(19) United States
(12) Patent Application Publication
(10) Pub. No.: US 2005/0177729 A1
(43) Pub. Date: Aug. 11, 2005

(54) Device and method for making secure sensitive data, in particular between two parties via a third party entity

(75) Inventor: Murielle Rose, Cuers (FR)

Correspondence Address: BURNS DOANE SWECKER & MATHIS L L P, POST OFFICE BOX 1404, ALEXANDRIA, VA, 22313-1404, US

(73) Assignee: Gemplus, Gemenos (FR)

(21) Appl. No.: 10/504,977

(22) PCT Filed: Feb. 18, 2003
(86) PCT No.: PCT/FR03/00529

(30) Foreign Application Priority Data
Feb. 18, 2002 (FR) 02/02028

(51) Int. Cl. H04K 1/00

(52) U.S. Cl. 713/182; 726/7

(57) ABSTRACT

A method for representing a first entity by a third party entity who is addressed by a second entity to request sensitive data from the first entity. The transmission of part at least of the sensitive data is controlled with a personal electronic medium held by the first entity. This medium can itself contain the sensitive data instead of the third party entity, and/or information for selectively locking or unlocking the third party entity if the latter holds it. The medium can be in the form of a smart card, for example a SIM card for the mobile telephone system.

The invention concerns the management of sensitive data in data exchange systems.

One example of such systems is based on the making of electronic contracts between two parties or entities, for example a service user and a service provider, by means of a third party entity. The latter then acts by representing the user, being able to negotiate in his name with service providers, whilst protecting his personal data.

In this context, there exist committees for standardising exchanges between access providers and users, respective parties to a contract. The organisation called “XNS.org”, whose Internet site is situated at the address http://www.xns.org/, is an example of such a committee, which specifies the role of a third party entity as a trusted intermediary on the Internet.

The latter party keeps in memory the characteristic data of a contract made between two entities, such as a user and a commercial entity for example. Thus, in the event of a subsequent dispute in the contract, such as the non-delivery of a product, non-payment, or improper broadcasting of personal data, the trusted intermediary provides electronic proof of the contract made.

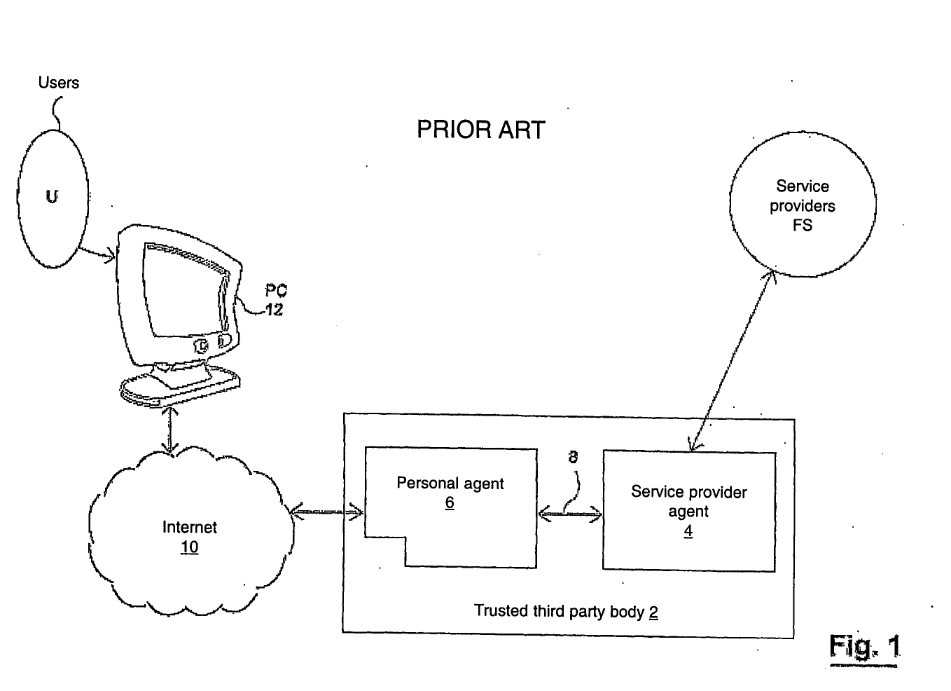

The operating principle of such an organisation is presented schematically in FIG. 1. The trusted intermediary 2 has two interfaces: a so-called “service provider agent” 4 which dialogues with the service providers FS, and a so-called “personal agent” 6 which dialogues with the users U. These two agents 4 and 6 dialogue with each other through a dedicated link 8.

In the example illustrated, the user U is connected to the personal agent 6 by the Internet 10, for example by means of a personal computer PC 12.

One drawback of this system is that the trusted third party body 2 needs to know all the personal data of the user in order to perform the transactions in place of the latter, and that these personal data are vulnerable from two points of view:
they are stored in a computer which is by nature not secure, and
they escape from the control of their owner.

As a result users are reticent, rightly, about leaving all their personal data on the site of the trusted body, some of these data being sensitive for the user U for various reasons, it being a case for example of his personal telephone number, information about his marital status, his bank details, his electronic business cards, his medical file, etc.

In the light of the above, the invention provides technical protection means able to be integrated functionally in such a system. These means are based on a personal electronic medium held by a user and able to dialogue with the personal agent or other trusted body. The medium manages, under the very control of its holding user, the disclosure of certain sensitive data where this user deems it undesirable to leave the management of the disclosure thereof to his personal agent. The sensitive data thus protected are selected by the user. It may concern any item of information which he deems sensitive, concerning his private, institutional, etc life.

More particularly, the invention provides, according to a first aspect, a method for representing a first entity by a third party entity to which a second entity applies in order to request sensitive data from the first entity,
characterised in that it comprises the following steps:
   the third party entity dialogues with the second entity and with the first entity by means of a personal agent interface;
   the first entity controls the communication by means of some of the sensitive data of the third party entity to the second entity by means of a personal electronic medium, by means of the following steps:
a security agent of the personal electronic medium provides the dialogue with the personal agent,
the security agent of the personal electronic medium provides the reading of at least the part of the sensitive data and/or criteria for inhibiting their disclosure.

According to this method, the control can be carried out by an interfacing with the user in order to obtain his authorisation or prohibition, provided by the security agent of the personal electronic medium, or by secure storage of at least some of the sensitive data in the personal electronic medium, outside the third party entity.

According to a second aspect, the invention provides a system for the exchange of data between a first and second entity by means of a third party entity, the system being characterised by a communication means in the third party entity and an electronic medium in the first entity comprising the characteristics described below.

According to a third aspect, the invention provides a personal electronic medium intended for the method according to the first aspect, comprising:
a memory area intended for storing at least one sensitive data item whose sending is to be managed and/or for the storage of a condition for the sending by the third party entity of at least one sensitive data item stored by it, and a security agent application which provides the dialogue with the personal agent of the third party entity, and which provides the reading of the memory.

According to a fourth aspect, the invention provides a communicating terminal enabling a first entity to communicate with a third party entity which represents him, characterised in that it uses a medium according to the third aspect.

According to a fifth aspect, the invention provides a third party entity representing a first entity, characterised in that it comprises means of dialoguing with a personal electronic medium according to the third aspect, making it possible to transmit at least one data item belonging to the first entity under the control of the said medium. This third party entity can store in memory the characteristics of a contract made between the first entity and a second entity.

The invention and the advantages which stem from it will emerge more clearly from a reading of the following description of a preferred embodiment, given purely by way of non-limiting example, with reference to the accompanying drawings, in which:

FIG. 1, already described, is a simplified diagram showing the functioning of a trusted third party body forming a link between service providers and users; and

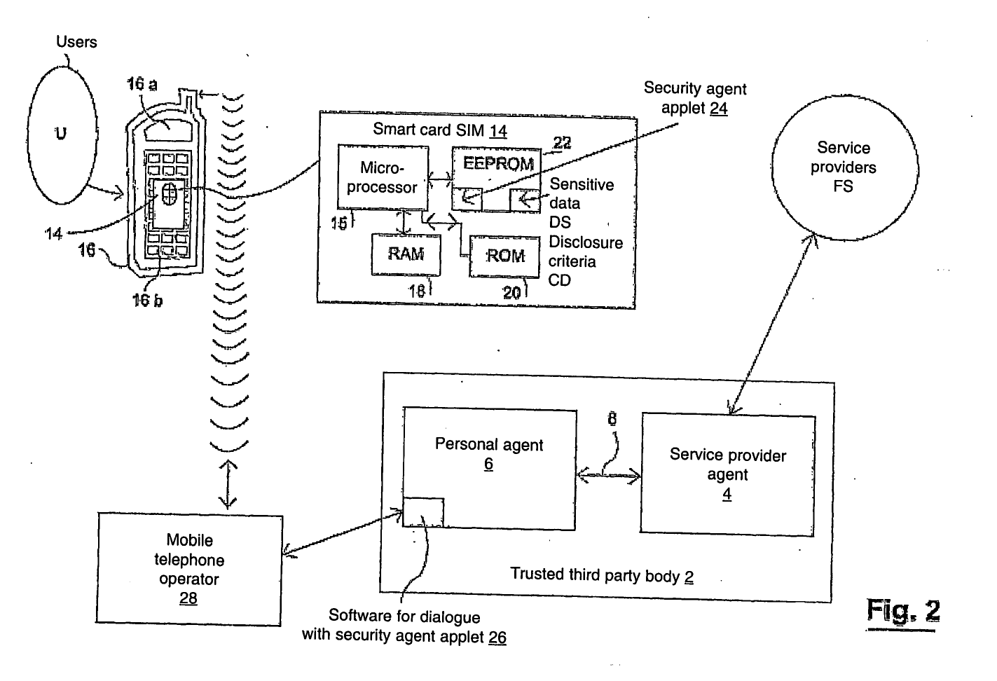

FIG. 2 is a diagram which repeats that of FIG. 1, adding the matters enabling the invention to be implemented according to a preferred embodiment.

The elements in FIG. 2 repeating those in FIG. 1 bear the same references and will not be described again for reasons of conciseness.

In accordance with the invention, a user U of the trusted third party body 2 has a personal electronic medium which provides the management of his sensitive data. The latter are the data for which he wishes to preserve a right of control with regard to their disclosure by the trusted body 2 to a service provider for example. The latter may be a commercial enterprise offering on-line services or wishing to prospect on line, an institutional body allowing exchanges at a distance, etc.

In the example, the personal electronic medium is a chip card 14 of the SIM or USIM type (the English acronym for “(universal) subscriber identification module”) integrated in a mobile telephony terminal 16 of the user U, thus conferring a new function on this card. This is because a SIM chip card comprises in itself sufficient basic technical resources to fulfil this function: microprocessor 15, memories: random access of the “RAM” type 18, fixed of the “ROM” type 20, electrically programmable of the “EEPROM” type 22, communication interface (by contacts), communication programs, means of loading data and programs, etc.

The card 14—which constitutes the personal electronic medium—takes part in the management in two possible ways:
by storing the sensitive data item or items DS in its own memory (for example the EEPROM memory 22), these data then not being stored with the personal agent 6, and/or
by exercising a capacity for inhibiting the disclosure of sensitive data stored by the personal agent.

Naturally the card 14 can selectively exercise one or other of these manners of acting according to the sensitive data in question.

The management at the card 14 is carried out by application software, referred to as “security agent application” 24, contained in the medium (for example in the EEPROM memory 22 of the card 14). The security application provides in particular: i) the dialogue with the personal agent 6, ii) the reading of the memory 22 storing the sensitive data DS and/or the criteria CD for inhibiting their disclosure and iii) interfacing with the user.

The personal agent 6 has for its part software 26 for dialoguing with the security application agent 24.

Several cases may arise for the transmission of sensitive data to a third party by the personal agent 6 under the control of the card 14:

1. First case: the personal agent 6 does not possess the sensitive data item and this data item DS is stored in the card 14. Two possibilities are then taken into account:
1.1. The user U agrees to transmit the sensitive data item routinely. The security agent application 24 in the card is then parameterised in order to extract the data item from the memory 22 in the card and to transmit it automatically to the personal agent 6 routinely at each request from the latter, without a request for authorisation from the user in person. The user nevertheless keeps the right to make this data item not open to access to the personal agent 6, either by deleting it from the memory 22 or by removing the card 14 from his terminal 16;
1.2. The user U does not agree to transmit the sensitive data item routinely. In response to a request from the personal agent, the security agent application 24 presents to the user a request for authorisation to transmit (with indication of the data item and its disclosure condition).

If the user expresses his acceptance, the security agent application 24 in response extracts the sensitive data item in question from the memory 22 and transmits it to the personal agent 6.

If the user refuses, the security agent application 24 locks the sensitive data item in its memory 22.

2. Second case, the personal agent 6 possesses the sensitive data item but in association with an indication not to disclose it to a third party except with the prior agreement of the user at each request. Two possibilities are then taken into account:
2.1. The security application agent 24 in the card 14 has an indication of the disclosure condition. The personal agent 6 indicates to the card, with its request, the disclosure condition (for example the name of the requesting third party). The security agent application 24 first of all determines whether it is in a position to reach a judgement on the condition transmitted by the agent. If the response is negative, it passes to the possibility presented at section 2.2 below; if the response is positive, it compares the condition indicated by the agent with that or those recorded for this data item.

If there is agreement, the security agent application 24 sends an enable signal to the personal agent 6, enabling the latter to disclose the data item to the requesting third party (for example a service provider FS).

If there is no agreement, the security application 24 sends an inhibit signal to the personal agent 6, preventing the latter from extracting the data item from its memory.
2.2. The security application agent 24 in the card 14 has not recorded conditions for disclosing the sensitive data item, or is confronted with a condition indication of a type not listed amongst its possible conditions (for example the name of a new third party). In response to a request coming from the personal agent 6, the security agent application 24 presents to the user U a request for authorisation of disclosure (with indication of the data item and its disclosure condition).

If the user expresses his acceptance, the security application 24 sends an enable signal to the personal agent 6, enabling the latter to disclose the data item to the requesting third parties.

If he expresses his refusal, the security agent application sends an inhibit signal to the personal agent, preventing the latter from extracting the data item from its memory.

In the embodiment, the security agent application 24 is in the form of an applet (referred to as a “security agent applet”) loaded in the card 14 either at personalisation or in post-personalisation.

The security agent applet 24 also manages the interface with the user U on the mobile telephony terminal 16, in particular in order to communicate to it a request for authorisation to transmit a sensitive data item or to accept an enable or inhibit signal for its access by the personal agent 6. This interface advantageously uses the display 16a of the mobile terminal in order to present the conditions and the keypad 16b for receiving a response from the user U.

The communication between the security agent applet 24 and the personal agent 6 takes place over the wireless channel “wireless” used by the mobile telephony terminal 16, for example according to the GSM protocol. In the example, this communication passes through an operator of the mobile telephony network 28 and the communications advantageously take place through SMS (from the English acronym “short message service”), EMS (from the English acronym “enhanced messaging service”) or MMS (from the English acronym “multimedia messaging service”) messages.

For its part, the security agent applet 24 can respond to the personal agent 6, via the dialogue software 26, also by means of SMS messages, the latter serving to transmit a sensitive data item, an enable signal or an inhibit signal.

There exist many possible protocols for coding the commands and signals exchanged between the security agent applet 24 and the dialogue software 26 of the personal agent 6.

By way of indication, each type of sensitive data can be described by a code according to a pre-established arrangement between the security agent applet 24 and the dialogue software 26 of the personal agent 6 (for example: code 012=social security N°). Likewise, the service providers FS requesting a sensitive data item can be coded by category (for example: code C08=insurance services commercial organisation) and by name (for example: code A19=La Picarde SA). One example of SMS content coming from the personal agent 6 to the security agent applet 24 would then be C08+A19+012. The security agent applet 24 can from this message deduce in which of the cases (cf. sections 1.1, 1.2, 2.1, 2.2 above) it is situated. It can thus, for example, display the following message on the screen 16a of the mobile telephone terminal “Request social security N° from La Picarde insurance company. Accept.: 1. Refuse 2.” Depending on whether the user hits key 1 or 2, this data item will be released or blocked for disclosure to this third party.

As required, the dialogue between the card 14 and the personal agent 6 can be protected by any known means (encrypting, etc).

The invention allows many variants, in particular with regard to:
the addressee of the sensitive data (or inhibit/enable signals) sent by the medium, this addressee being able to be any private or public centralised management system,
the personal electronic medium held by the user, this medium being able to be a chip card of any type, an electronic token, an electronic badge, or any other personal electronic object for communicating via a platform or by itself,
the terminal on the user side, this terminal being able to be any mobile telephone, fixed telephone, communicating personal digital assistant, personal computer, etc,
the connection connecting the hardware medium held by the user or its terminal with the addressee of the sensitive data, this connection being able to be based on any wireless or cabled communication protocol,
the protocol for commands, for identification of the sensitive data and the inhibit/enable signals, or for communication with the user,
institutional and commercial applications,
etc.

By way of illustration, the security agent applet 24 (or the like) can be provided for transmitting a secure data item not in return to the personal agent 6 (or the like) that sent the request, but directly to the final destination (for example the service provider FS), by calling the connection number of the latter.

The hardware medium 14, 16 held by the user can also allow an updating or controlled loading of the sensitive data from the personal agent 6 (or any other authorised third party). The security agent applet 24 will then provide the enabling of the loading or of the modification under the control of the user, either by presenting to it the loading or updating request with the possibilities of accepting or refusing, or executing an automatic filtering on the basis of criteria fixed in advance by the user.

The invention is suitable for financial transactions, in particular for processing electronic payment in an electronic commerce context. For example, the banking details will be stored within the chip card of the personal electronic medium and used in the way described above at section 1.2.

1. A method for representing a first entity by a third party entity to which a second entity applies in order to request sensitive data from the first entity, comprising the following steps:
conducting dialogs between the third party entity and each of the second entity and the first entity by means of a personal agent interface; and
controlling communication of some of the sensitive data from the third party entity to the second entity by means of a personal electronic medium associated with the first entity, by means of the following steps:
conducting a dialog between a security agent (24) of the personal electronic medium and the personal agent, and
reading by the security agent of the personal electronic medium, of at least part of the sensitive data and/or criteria for inhibiting their disclosure.

2. A method according to claim 1, wherein said controlling step includes interfacing between the user and the security agent of the personal electronic medium to obtain an authorization or prohibition.

3. A method according to claim 1, wherein said controlling step is carried out by secure storage of at least some of the sensitive data in the personal electronic medium, outside the third party entity.

4. A method according to claim 3, wherein the stored data are transmitted to the third party entity to perform a financial transaction in the context of an electronic operation.

5. A method according to claim 1, wherein the communication between the personal electronic medium and the third party entity is made by a wireless link.

6. A method according to claim 4, wherein the communication between the personal electronic medium and the third party entity is made by a mobile telephony operator.

7. A personal electronic medium comprising:
a memory area storing at least one of a sensitive data item whose sending is to be managed and/or a condition for sending by a third party entity at least one sensitive data item stored by it, and
a security application agent which conducts a dialogue with a personal agent of the third party entity, and which performs reading of the memory.

8. A personal electronic medium according to claim 7, wherein the security agent also performs interfacing with a user in order to request authorization or prohibition of disclosure of sensitive data.

9. A medium according to claim 7, in the form of a chip card.

10. A medium according to claim 9, wherein said chip card provides services for the functioning of a mobile telephony terminal.

11. A communicating terminal enabling a first entity to communicate with a third party entity which represents it, comprising a personal electronic medium according to claim 7.

12. A system for enabling a third party entity to represent a first entity, comprising means for dialoguing with a personal electronic medium according to claim 7, to control transmission from said third party entity to a second entity at least one data item belonging to the first entity.

13. A system according to claim 12, further comprising means for storing the characteristics of a contract made between the first entity and a second entity.

14. A system for exchange of data between a first entity and a second entity by means of a third party entity to which the second entity applies in order to request sensitive data from the first entity, comprising:
a personal agent communication means at said third party entity for communicating with the first entity and with the second entity, and
a personal electronic medium at the first entity which comprises:
a memory area storing at least one of a sensitive data item whose sending is to be managed and/or a condition for the sending by the third party entity of at least one sensitive data item stored by it, and
a security application agent for conducting a dialogue with said personal agent of the third party entity and for reading the memory.
